(19) United States
(12) Patent Application Publication
(10) Pub. No.: US 2004/0006567 A1
(43) Pub. Date: Jan. 8, 2004

(54) Decision support system using narratives for detecting patterns

(75) Inventors: Cynthia Kurtz, Edinburg, NY (US); David Snowden, Marlborough (GB)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY

(21) Appl. No.: 10/187,758

(22) Filed: Jul. 2, 2002

(51) Int. Cl. G06F 7/00

(52) U.S. Cl. 707/100

(57) ABSTRACT

A method for providing a decision support system, has the steps of: (a) storing in a database a plurality of documents, each document representing a narrative and each document being tagged with metadata; (b) searching the database for a narrative that corresponds to a search criteria of the data in the metadata in the narrative; and (c) displaying a set of results.

### FIELD OF THE INVENTION

The present invention relates to the field of decision support systems and particularly to the use of narratives and tagging to detect patterns that occur within the narratives.

### BACKGROUND TO THE INVENTION

Since ancient times human beings have told stories for many purposes, including the transfer of knowledge, values and beliefs. Stories quickly convey complex messages to diverse audiences. One of the oldest uses of storytelling is in providing a different perspective. The very act of listening to a story requires the willing suspension of one's own perspective to temporarily entertain another view of the world. By looking at a situation from a different perspective, people and in particular decision makers can gain a better understanding of why people behave as they do, for example the way people in different cultures tend to act under a particular condition.

Stories or narratives can be used effectively to aid people in making decisions, particularly to detect emerging patterns about complex issues such as are found in corporate strategy and foreign policy. By detecting these emerging patterns decision makers are better equipped to deal with complex situations that require complex decision making techniques. A complex situation can be described as one in which, the interactions of many identities make simple predictions impossible, for example in financial market places.

Decision support systems exist that aid a person in decision making but these tend to be for very narrow subject or knowledge domains for example financial management and mathematical statistical analysis. These types of decision support systems therefore can not be utilized across many different knowledge domains and the knowledge within the decision support system is tightly scoped and therefore has limited use. Current state of the art decision support systems do not use narratives as a means for detecting patterns as until now there has been no mechanism to aid the retrieval process of such narratives and to provide a mechanism in which to detect patterns in the narratives in a meaningful manner to aid decision making.

### SUMMARY OF THE INVENTION

In accordance with the present invention there is now provided a method for a decision support system, the method comprising the steps of: (a) storing in a database a plurality of documents, each document representing a narrative and each document being tagged with metadata;(b) searching the database for a narrative that corresponds to a search criteria using the metadata in the narrative; and (c) displaying a set of results.

Because a narrative is tagged with metadata that is relevant to the environment in which the narrative was captured and a plurality of the tagged narratives are stored in a database, the database can be searched to find a narrative situated in a meaningful context to a user. This allows for emerging patterns to be detected, for example changes in cultural beliefs over time or mismatches between viewpoints.

Viewed from another aspect the present invention provides a system for carrying out the method described above.

Further, the invention provides a computer program product for instructing a data processing system to carry out the method described above.

### BRIEF DESCRIPTION OF THE DRAWINGS

The invention will now be described, by way of example only, with reference to a preferred embodiment thereof, as illustrated in the accompanying drawings, in which:

FIG. 1, illustrates the decision support system, running on a data processing system, according to a preferred embodiment of the present invention;

FIG. 2, illustrates the steps that the decision support system carries out, according to a preferred embodiment of the present invention;

FIG. 3, illustrates the interface of the decision support system of FIG. 1, according to a preferred embodiment of the present invention; and

FIG. 4, illustrates a narrative tagged with a markup language as it would be stored in the database of FIG. 1, according to a preferred embodiment of the present invention;

### DESCRIPTION OF THE PREFERRED EMBODIMENT

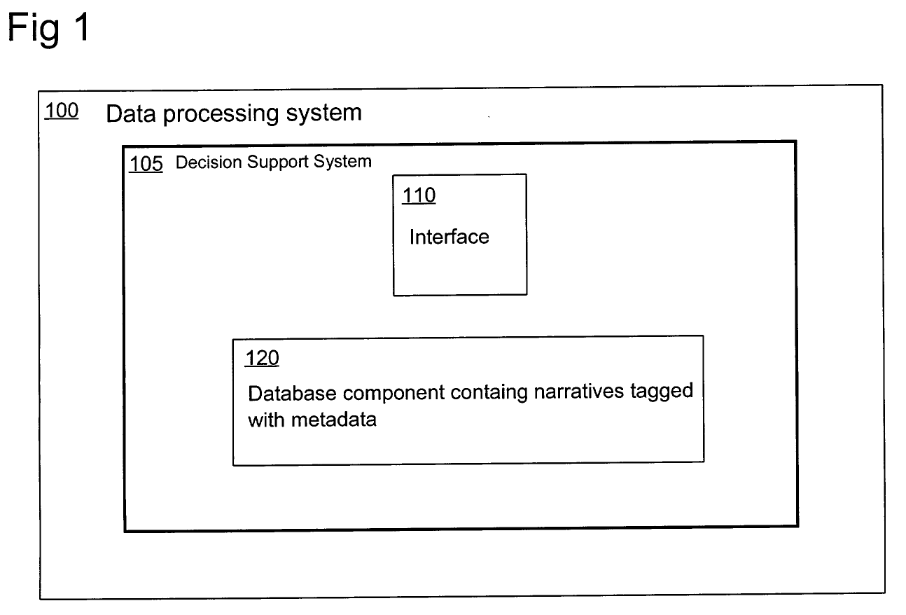

A user of a decision support system 105 in FIG. 1, is provided with a meta model which, allows the user of the decision support system to approach decision making in a variety of different contexts. For example the meta model can enable the user to decide what status they are ‘at’ regarding a particular situation and to enable the user to select the most appropriate decision making method to use. The meta model provides different types of classification that particular problems are characterized by. Examples of classifications for decision making are knowable systems, where cause and effect relationships can be discovered through scientific methods, known systems where cause and effect relationships are static or predictable, complex systems such as an organization whose identities and interactions are dynamic and irreducible and chaotic systems where no connections are found. An example of the different types of systems is one in which a user might realize that although they had once been in a stable, knowable situation with regards to a certain opponent, recent changes have moved the situation into a more complex space. The meta model can be further used to consider how different people or groups might see a current situation given their differing opinions or world views.

FIG. 1, illustrates a decision support system 105 running on a data processing system 100. The decision support system 105 comprises an interface 110 and a database 120, where each document stored in the database represents a narrative tagged with metadata.

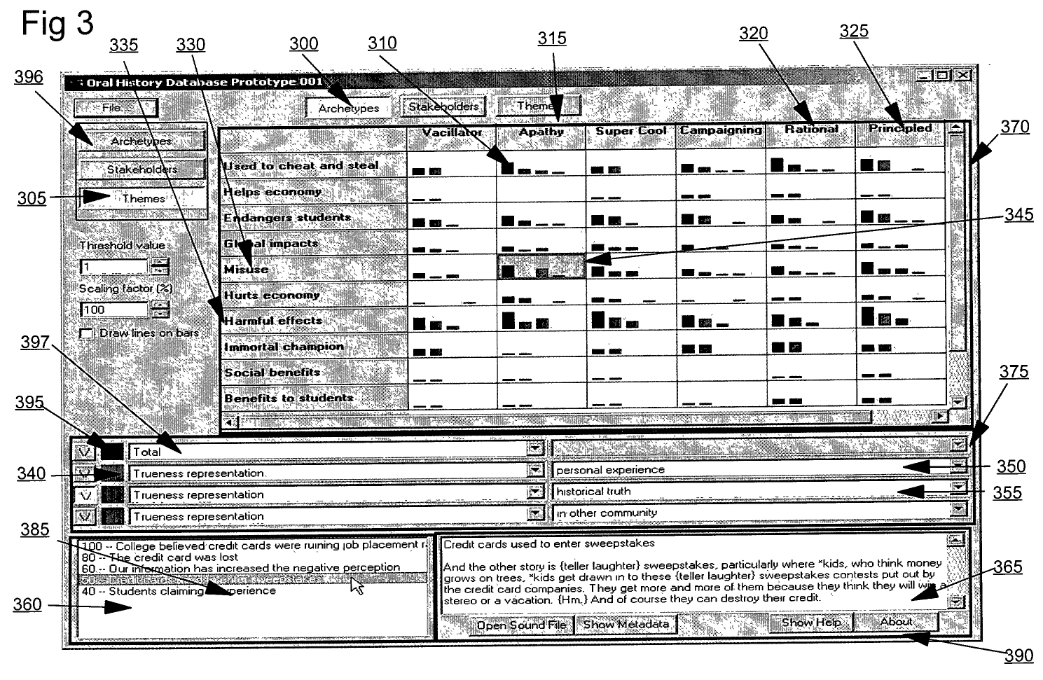

The interface 110 of the decision support system 105 can be understood with reference to FIG. 3. The interface 110 comprises a graphical user interface used for the input of a search criteria, the retrieval of one or more tagged narratives requested by the search criteria and for displaying the results in response to the search criteria. The search criteria is entered into the interface 110 by selecting criteria from a plurality of selection boxes as shown in section 375 and a plurality of input boxes as shown in section 395. The search criteria is built using a combination of the input from both the selection boxes and the input boxes.

The results are displayed in a variety of ways. Firstly, by referring to section 370, the results of the search are displayed as a plurality of bar charts, each bar chart situated in an individual cell and each cell has a legend which depicts a category on a vertical axis 330 and a category on a horizontal axis 315. The individual bar charts illustrate narrative patterns that occur in the tagged narratives stored in the database 120. Narrative patterns are contextual details as to how the narratives were told and heard in the community, such as the source of the narrative, motivations of the narrative being told and emotional content of one or more archetypes in the narrative. In section 375 there are 8 selection boxes which, represent the narrative patterns in the stored narratives. Each row of selection boxes has a designated color for example, the first row may have the color blue, which is shown as a blue box to the right of the first row 395. In this case the user has selected to see the total number 397 of narratives patterns that represent the search criteria. The results from the user selecting this particular search criteria is shown as the first bar 310 of each individual bar chart in each cell. The first bar 310 of the bar chart corresponds to the color designated to the selection box 395, thus the individual colors designated to each selection box acts as a legend for the individual bar charts. Hence the interface 110 provides a very quick and easy way to see the narrative patterns.

Secondly, the narratives that have been retrieved as a result of a search are displayed in a list box as shown in section 385. In the example given in FIG. 3, it can be seen that a total of 5 narratives have been retrieved resulting from the search criteria entered by the user. A user can select any one of the listed narratives to read and the selected narrative is displayed in section 390.

The user can navigate around the interface 110 by using a standard input device such as a keyboard or a pointing device such as a mouse for manipulating a screen cursor. In response to a user's movement from an input device or pointer device, the user may generate user event signals for example, ‘drag and drop’, using the mouse for selecting and manipulating selection boxes, input buttons and list boxes as is known in the art.

The interface 110 may be embodied on a variety of different platforms for example a database package such as, Microsoft Access, which is a registered trade mark of Microsoft Corporation or Lotus Approach, which is a registered trade mark of Lotus Corporation, or using a programming language such as Microsoft C++, Visual Basic or Java. Microsoft C++ and Visual Basic are both registered trade marks of Microsoft Corporation and Java is a registered trade mark of Sun Microsystems.

The interface 110 of FIG. 1, will now be explained further, by way of an example with reference to FIG. 3, which illustrates a list of retrieved narratives as shown in section 385. In this example the user of the decision support system 105 is trying to understand why their company is experiencing problems with products misused by their customers, such that the company is faced with a public backlash. The user first selects a search criteria which represents the key points of the narrative that the user wishes to look at. The user has chosen a search criteria of ‘Archetypes’ 300 and ‘Themes’ 305, by which to navigate the tagged narratives stored in the database 120. In this example, the narrative patterns that represent the different search criteria are visible in the interface 110 as the first bar in each cell 310. It is evident in this example that the majority of narratives are about the ‘Apathy’ 315, ‘Rational’ 320 and ‘Principled’ 325, archetypes rather than the remaining archetypes of ‘Vacillator’, ‘Super cool’ and ‘Campaigning’ and that narratives about ‘Misuse’ 330 and ‘Harmful effects’ 335, are more prominent than other themes.

In the ‘Apathy-Misuse’ cell 345, there are no narratives from ‘personal experience’ 350 represented as the second bar in the ‘Apathy-Misuse’ cell, but several in the ‘historical truth’ category 355 represented as the third bar in the ‘Apathy-Misuse’ cell, and several narratives that are passed around other communities as being true and not needing proof of truthfulness. This illustrates that the staff members at the company from whom the narratives were collected based their opinions about customer misuse of their product more on hearsay than on direct experience. This is an example of pattern detection that can aid decision making. By using the interface 110 to select a search criteria and search the narratives stored in the database 120, the user is able to explicitly compare a current situation to a historical situation sharing deep similarities to determine if any new insights or options can be found that were not conceivable before or build a logical argument from the search results, build a coherent story from a series of narratives in order to describe a complex situation or build a counter point argument to look at both perspectives of an issue.

The database 120 of FIG. 1, contains a plurality of documents and each document represents a tagged narrative. The narratives may be primary narratives which consist of oral history narratives, anecdotes, narratives derived from collective storytelling sessions, one to one interviews, anonymous virtual story telling and anthropological observations. Also secondary narratives can for example, come from materials such as documentaries, books, articles, news feeds, research projects, government inquires, military and police investigations. It is important to note that a narrative is a story as told by a person and as such the person is not guided by questions posed to them by another person wishing to elicitate knowledge. By using narratives from a variety of different sources the scope of the decision support system 105 covers a broad knowledge base.

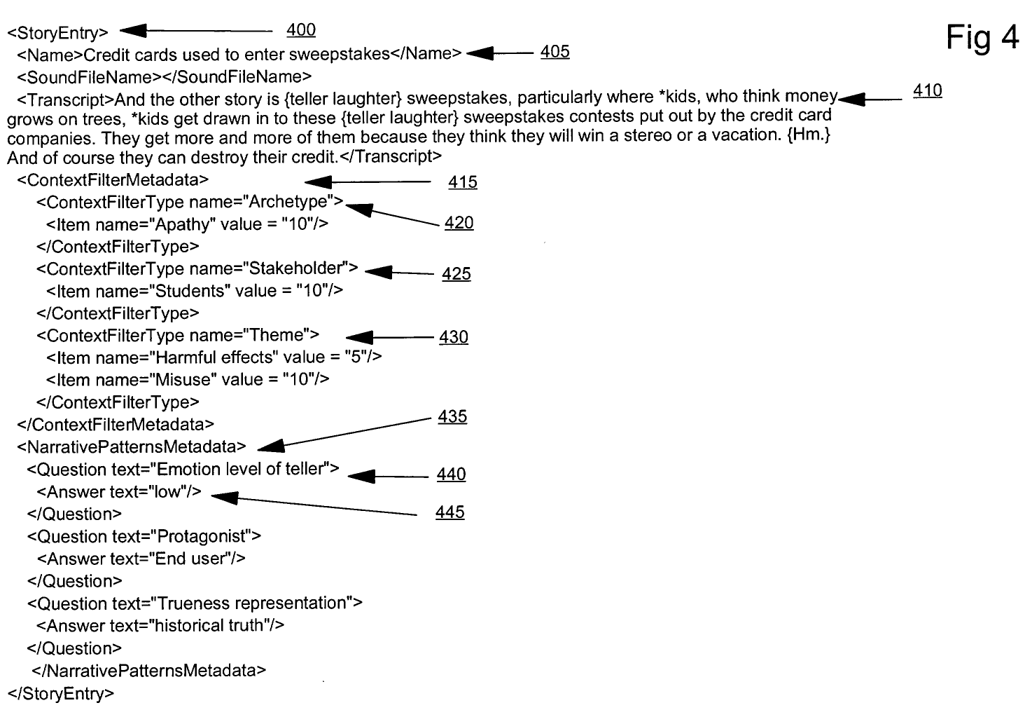

A variety of database platforms may be used, from a relational database such as Microsoft Access, which is a registered trade mark of Microsoft Corporation, a hierarchical database such as Lotus Notes or any other robust database system, a programming language that allows the programming of such a system or a markup language such as Exentsible MarkUp Language (XML). FIG. 4 illustrates an example of a narrative tagged with metadata as it would be stored in the database 120 of the decision support system 105 of FIG. 1.

A tag for a narrative consists of metadata, which is contextual data that is encoded with each narrative in the database 120. The tags are provided by a markup language such as XML. XML is a universal format for structured documents on the world wide web. XML is a set of rules for designing text formats that allow data to be structured using tags (words bracketed by ‘<’ and ‘>’) and attributes (of the form name=“value”) to delimit the metadata. The metadata defined by the attributes provides a classification for the metadata (name=“archetype”), where the metadata “archetype” forms part of the classification.

Referring to FIG. 4, it can be seen what a narrative looks like when it is tagged with a markup language. The tags begin with the symbols ‘< >’, which indicate the beginning of a tag and end with ‘</>, which indicate the end of a particular markup tag. To aid narrative pattern detection, the narrative is encoded with as much metadata as possible so that a user can view a narrative in context to the environment in which it was captured. The markup language first declares a tag called ‘<storyEntry>’ 400, which identifies it as a narrative. Next, the markup language declares a tag called <Name> 405 which, identifies the name of the narrative. The body of the narrative is contained within the tag <Transcript> 410 and includes the narrative as told by the storyteller and metadata such as whether the storyteller laughed, sighed or was particularly emotional. The metadata tags begin with the <ContextFilterMetadata> tag 415 which identifies that this is where the metadata relating to the classifications begin.

The attributes of the markup language that form the classifications of the metadata are identified by the <ContextFilterType name=“Archetype”> 420, <ContextFilterType name=“Stakeholder”> 425 and <ContextFilterType name=“Theme”> 430. In FIG. 3, the ‘Archetype’ 300, the ‘Stakeholder’ and the ‘Theme’ 305 classifications are displayed as input buttons on the interface 110.

Turning back to FIG. 4, a narrative pattern metadata tag 435 is used to tag the questions and answers that detect patterns in the narratives. A question is tagged to the narrative as <Question text=“Emotion level of teller”> 440 and the answer is tagged to the narrative as <Answer text=“low”/> 445. Referring back to FIG. 3, the narrative that the user has selected to view in section 385, is the same narrative that can be seen with its metadata tags in FIG. 4.

The narrative pattern metadata that is tagged to a narrative is derived by using a large set of nested questions that a person could answer about a particular narrative. For example, this could be questions about the characters in the narrative, the plot, the setting, emotional level of the story teller and why the narrative was told. Subsets of metadata are chosen to describe a particular narrative depending on the amount of information available about its context. For example, a narrative submitted to a web discussion group will have a small subset of metadata associated with it whereas, a narrative captured during a group discussion will have a larger subset of metadata associated with it. A subset of questions are selected and the narratives are tagged with the answers to the questions. The narratives are tagged again with the metadata attributes and classifications and the tagged narratives are stored in the database 120. The attributes and classifications metadata tags are derived from the interaction of diverse groups of people, for example, people from different parts of society by attending a workshop. A workshop is a collection of people with a facilitator, who directs the group through different scenario's or activities using a metamodel. The group of people attending the workshop follow the meta model directed by the facilitator to consider, compare, merge and construct contemporary and historical narratives with respect to a subject that they have been asked to explore for example, using the example in FIG. 3, why a customer's product is being misused. The group of people are guided through a process of discarding particular biased and stereotypical first class classifications and arrive at recognizable classifications for example a classification of an archetype character might be a ‘staunch defender’ or a ‘big bully’.

The attributes of the metadata form an indexing mechanism, which is based on two factors. The first factor is socially relevant classifications consisting of, for example, archetypal characters or situations. The classifications provide a means by which users of the decision support system 105 can view narratives as connected to other related categories rather than in isolation. The second factor is information that captures as much detail as possible regarding the context in which each particular narrative was told and heard, for example its source, emotion and motivation and provides a means by which users of the decision support system can view narratives which are not torn out of context but situated in context, so that the user can judge a particular situation side by side with many other narratives concerning the same situation.

Assignment of the markup language questions, answers, classification and attributes is carried out by either a) manually tagging a narrative with metadata or b) tagging narratives with metadata which are suggested or supplied by neural networks (a well known artificial intelligence technique). Neural networks are used to suggest answers to a selection of the markup language questions. The neural network is supplied with one or more narratives that are already tagged and this is used as training material for the neural network. The neural network is then able to suggest answers to some of the questions such as the emotionality of a narrative teller and audience, purpose of the narrative telling, relationship of the narrative. The narrative is then tagged with the metadata suggested by the neural network.

The tagging of the narratives is normally carried out before the tagged narratives are stored in the database 120 of the decision support system 105 of FIG. 1, however, the narratives could equally be stored in the database 120 of FIG. 1, without being tagged and then tagged at a later date for use in the decision support system 105.

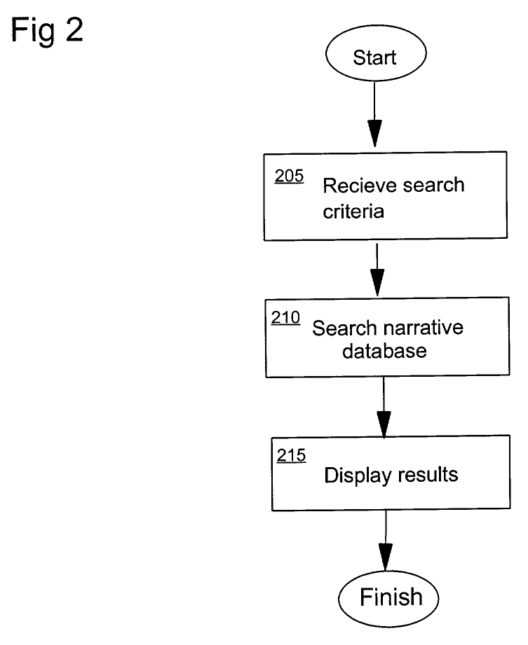

With reference to the flowchart of FIG. 2, it will be explained how the interface 110 and the database 120 of FIG. 1 interact with each other. The user builds a search criteria from the plurality of selection boxes 375 and input buttons 395 of FIG. 3 and the search criteria is entered into the decision support system at step 205. A search string is then formed with the search criteria that was input into the decision support system 105 from the interface 110. The database 120 takes the search string and searches the stored narratives at step 210, using the indexing mechanism to find and retrieve one or more narratives that match the search criteria. Once one or more narratives are found that fit the search criteria, the results are retrieved and the results are displayed at step 215.

By using the example in FIG. 3, about customer misuse of products, the steps that the decision support system 105 carries out can be further understood. The user selects a search criteria (at step 205), in this example, the user has chosen to look only at narratives that feature the ‘Apathy’ archetype and the ‘Misuse’ theme in which the storytellers (known in this case to be staff members) have represented the narratives as ‘historical truth’. The interface 110 takes the search criteria as the input to the decision support system 105 and forms a search string therefrom. The database 120 uses the search string and searches the database (at step 210) to find and retrieve one or more narratives that match the search criteria. Once one or more narratives are found, the results are retrieved and the results are displayed (at step 215) in display areas 370 and 385 of FIG. 3. The narratives are shown in order of how strongly they match the search criteria. The user can select a particular narrative from the list of narratives meeting the selection criteria, and can read the story in order to gain a deeper understanding of the topic at hand (how staff members talk about customers who are apathetic and misuse the product). An audio file and video file of a narrative can be called up and reviewed, as can its entire set of metadata.

Further meta models are used in conjunction with the decision support system 105 to help the user understand the decisions that the user is required to make. Diagnostic meta models are used to remove any bias and limited perspective from a decision making processes for example trying to understand the perspective of a teenager who constantly reoffends.

Users are able to internalize the diagnostic meta models by using them in various exercises designed to help them become familiar with the use of the models for critical thought and decision making. These exercises might be individual and or collective or virtual and or physical. For example users might be placed in a micro world training session where the users are given a situation in which they are asked to evaluate or simulate historical problems and derive options from the situations that the users feel that they could use if faced with having to make a decision in such a situation.

Users are able to understand the diagnostic meta models and the conceptual underpinnings of the diagnostic meta models by reading and viewing multimedia explanations about critical concepts as well as attending physical and virtual training sessions.

User are able to contextualise the diagnostic meta models to their unique needs and an environment that they are exploring by making sense of them within the context of the decision that they are faced with. For example a user may be asked to explain historical cases from a piece of literature or from their own experience in the terms of the diagnostic meta models and arrive at alternative endings that could be chosen.

Users can apply the diagnostic meta models in their practice of decision making by using them as ‘action filters’ for choosing different decision making activities for example choosing among such methods as scenario planning, forecasting, simulation, role playing, logical argument building and statistical analysis. The user is further able to link particular details of a situation of concern to relevant abstract concepts and conditions in the diagnostic meta models thus describing the situation in ways that increase the user's understanding of the situation for example finding shift in power structures as played out in recent events, looking for boundary conditions between states and movements over boundaries for example, thinking about what would happen if market reforms led to an unemployment rate increasing beyond the buffer capacity of an unofficial economy. The user is able to deliberately consider a situation from more than one perspective or alternative explanation in order to disrupt entrained thinking about a cause of a situation for example looking at a recent treaty offer as if it were intended to mislead to see if looking at it in this manner might reveal something that has been overlooked before.

1. A method for providing a decision support system, the method comprising the steps of:
(a) storing in a database a plurality of documents, each document representing a narrative and each document being tagged with metadata;
(b) searching the database for a narrative that corresponds to a user input search criteria using said metadata in the narrative; and
(c) displaying a set of results.

2. A method as claimed in claim 1, wherein the metadata comprises attributes and classifications which convey patterns within the narrative.

3. A method as claimed in claim 1, wherein the metadata corresponding to a narrative located in the database is searched in a context that is relevant to a particular situation.

4. A method as claimed in claim 1 wherein, a tagged narrative is tagged using a markup language.

5. A method as claimed in claim 1, wherein the user input search criteria is input to the decision support system using a graphical user interface.

6. A method as claimed in claim 1, wherein step (c) displays patterns that occur in the narratives.

7. A method as claimed in claim 2, wherein a metamodel is used to derive the attributes and classifications.

8. A computer program product comprising computer program code stored on a computer readable storage medium, which when executed on a data processing system, instructs the data processing system to carry out the method as claimed in claim 1.

9. A system for providing a decision support system, the system comprising:
(a) means for storing in a database a plurality of documents, means for each document representing a narrative and means for each documents being tagged with metadata;
(b) means for searching the database for a narrative that corresponds to a user input search criteria using said metadata in the narrative; and
(c) means for displaying a set of results.

10. A system as claimed in claim 9, wherein the metadata comprises means for attributes and classifications which convey patterns within the narrative.

11. A system as claimed in claim 9, wherein means for the metadata corresponding to a narrative located in the database is searched in a context that is relevant to particular situation.

12. A system as claimed in claim 9, wherein, means for the tagged narrative to be tagged using a markup language is provided.

13. A system as claimed in claim 9, wherein means for the user input search criteria is input to the decision support system using a graphical user interface.

14. A system as claimed in claim 9, wherein means for step (c) displays patterns that occur in the narratives.

15. A system as claimed in claim 10, wherein means for a metamodel is used to derive the attributes and classifications.
